(19) United States
(12) Patent Application Publication
(10) Pub. No.: US 2008/0012922 A1
(43) Pub. Date: Jan. 17, 2008

(54) Apparatus for Printing Labels

(76) Inventor: Johannes Lenki, Freising (DE)

Correspondence Address: Jonathan A. Platt;Renner, Otto, Boisselle & Sklar, 1621 Euclid Avenue, 19th Floor, Cleveland, OH, 44115, US

(21) Appl. No.: 11/578,907

(22) PCT Filed: Apr. 19, 2005
(86) PCT No.: PCT/EP05/04177

§ 371 Date: Oct. 20, 2006

(30) Foreign Application Priority Data
Apr. 20, 2004 (DE) 10 2004 019 076.3

(51) Int. Cl. B41J 3/407

(52) U.S. Cl. 347/106

(57) ABSTRACT

Apparatus for printing labels comprising a printing unit 2 and a feed device 1 in which the respective label is fed to the printing unit, wherein the feed device 1 has an intake device 3 which draws in an introduced label and moves it to the printing unit 2, wherein the label can be moved back through the intake device 3 again in the push-out discharge direction.

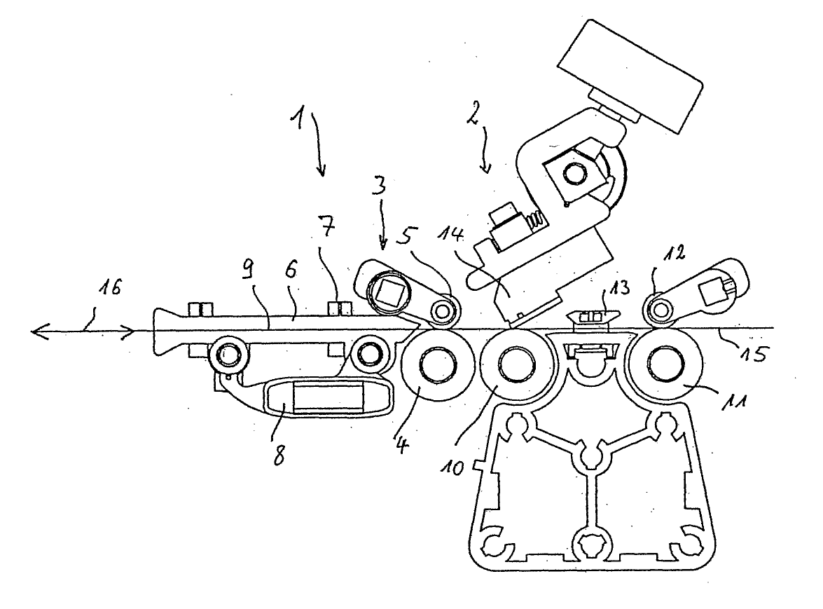

The invention concerns an apparatus for printing labels as set forth in the classifying portion of claim 1.

Such an apparatus is known from WO02/35463 A2. The known apparatus has a printing unit to which labels to be printed upon are fed by way of a feed device. The labels can be in particular RFID labels. The arrangement also has a reading unit for the RFID labels.

The object of the invention is to provide an apparatus of the kind set forth in the opening part of this specification, in which the feed of labels to the printing unit and possibly removal of the labels therefrom is facilitated.

According to the invention that object is attained by the characterising features of claim 1. The appendant claims recite advantageous developments of the invention.

In the case of the invention the feed device is characterised by an intake device which draws in a label which has been introduced by hand or by machine and moves it into the printing unit.

For that purpose the intake device can have a drivable transport roller which moves the label in the intake direction to the printing unit. There can also be at least one pressure roller which presses the label against the transport roller.

Preferably the transport roller is drivable in two mutually opposite directions of rotation, namely the intake direction and a push-out discharge direction in opposite relationship thereto. In that way it is possible for the label to be moved back from the printing unit into the feed device again, from which it can be removed by hand or by machine or otherwise. The drive for the transport roller in the discharge direction can be switched on for example when the printing operation is concluded.

In addition the feed device can have a guide device in which a respective label is guided to the transport roller. It is possible to provide in the feed device a detector which is preferably in the form of a light barrier assembly and which detects a label guided in the guide device to the transport roller and switches on the drive for the transport roller. The transport roller then conveys the label to the printing unit. After the printing operation is concluded the transport roller can be driven in the opposite direction so that the label is removed from the printing unit and moved back into the guide device from which it can be removed manually or by machine.

Advantageously the label can remain joined to an article, for example an item of baggage, an article of clothing or the like, in the process of being drawn into the printing unit, in the printing operation and upon removal from the printing unit. The guide device and the intake device ensure that the label is introduced into the printing unit in suitable positioning for the printing operation. It is naturally also possible for the label to be introduced into the printing unit, in a condition of being detached from the article.

In addition preferably provided in the region of the guide device is an identification device, for example in the form of a reading unit, with which the encoded or uncoded content of the label which is in the guide device can be read and identified. Printing on the label can then be effected in dependence thereon, after it has been introduced into the printing unit.

Preferably the apparatus is used in relation to RFID labels. In that case the identification device is in the form of an RFID unit. Activation of the reading operation can also be effected by the detector which for example is in the form of a light barrier assembly as soon as it has detected the presence of the label in the guide device.

The invention will now be described in greater detail with reference to the FIGURE which is a diagrammatic side view of an embodiment by way of example.

The illustrated embodiment shows a printing unit 2 which in known manner comprises a printing head 14 and a platen roller 10. In the printing operation the label to be printed is guided between the printing head 14 and the platen roller 10.

A feed device 1 is provided for feeding the respective label. It includes a guide device 6 with a guide path 9 in which the respective label is guided after being introduced thereinto. The operation of introducing the label into the guide path 9 can be effected by hand or by machine. Provided at the guide device 6 is a detector 7 which is preferably in the form of a light barrier assembly and which detects the presence of a label in the guide path 9. As soon as the detector 7 has detected a label in the guide device 6 an identification device 8 which in particular is in the form of an RFID reading unit with corresponding antenna is activated to read the information contained on the label, in particular the RFID label.

The feed device 1 further includes an intake device 3 arranged between the guide device 6 and the printing unit 2. The intake device 3 includes a transport roller 4 which is preferably drivable in an intake direction and in a discharge direction in opposite relationship thereto. Preferably the drive (not shown) of the transport roller 4 is switched on by the detector 7 as soon as it has detected a label in the guide device 6. The label which has been advanced as far as the transport roller 4 and which is pressed against the transport roller 4 by means of one or more pressure rollers 5 is then drawn in and transported between the printing head 14 and the platen roller 10 of the printing unit 2.

After termination of the printing operation the transport roller 4 is driven in the push-out discharge direction in opposite relationship to the intake direction and the label is removed from the printing unit 2. The label is moved back into the guide device 6 and can be removed therefrom by hand or by machine.

Advantageously, in the above-outlined procedures, the label can remain joined to the article to be identified thereby. It is however also possible for the label to be fed to the printing unit 2 in a detached and separate condition, and to be removed again therefrom, as described above.

With the illustrated embodiment it is also possible for the label to move through the printing unit 2 in a uniform transport direction. For that purpose the illustrated embodiment has a further transport roller 11 with at least one associated pressure roller 12, between which the label which is to be removed from the printing unit 2 is transported into a storage device (not shown). The length of the label to be transported out of the printing unit 2 can be detected by means of a further detector 13 which is preferably in the form of a light barrier assembly, and the drive for the transport roller 11 can be suitably switched off.

In the FIGURE, a label path 15 along which the label is transported through the apparatus is shown as a solid line. A double arrow identifies draw-in and push-out directions 16 with which, as discussed above, the label is preferably drawn in and transported to the printing unit 2 and moved back therefrom in the opposite direction (push-out discharge direction) back to the guide device 6 again.

1. Apparatus for printing labels comprising a printing unit and a feed device in which the labels are fed to the printing unit,
characterised in that the feed device has an intake device which draws in a label which has been introduced into the feed device and moves it into the printing unit.

2. Apparatus according to claim 1 characterised in that the intake device has a drivable transport roller which draws in the label in an intake direction and moves it to the printing unit.

3. Apparatus according to claim 1 characterised in that there is provided at least one pressure roller which presses the label onto the transport roller.

4. Apparatus according to claim 1 characterised in that the feed device further has a guide device in which a respective label is guided to the transport roller.

5. Apparatus according to claim 1 characterised in that provided in the feed device is a detector which in particular is in the form of a light barrier assembly and which detects a label present in the guide device and switches on the drive of the transport roller.

6. Apparatus according to claim 1 characterised in that provided at the guide device is an identification device which identifies and/or reads a respective label disposed in the guide device.

7. Apparatus according to claim 5 characterised in that the identification device is activated by the detector.

8. Apparatus according to claim 1 characterised in that the transport roller is drivable in two directions of rotation.

9. Apparatus according to claim 1 characterised in that the label can be removed from the printing unit by driving the transport roller in a push-out direction in opposite relationship to the intake direction.

10. Apparatus according to claim 9 characterised in that the label which is moved in the push-out direction is arranged for removal in the guide device.

11. Apparatus according to claim 1 characterised in that the guide device has a guide path for the label.

12. Apparatus according to claim 1 characterised in that the respective label is in the form of an RFID label.

13. Apparatus according to claim 12 characterised in that provided at the guide device is an identification device which identifies and/or reads a respective label disposed in the guide device, and in that the identification device is in the form of an RFID unit.

14. Apparatus according to claim 1 characterised in that the label remains joined to an article upon being drawn into the printing unit and upon being removed from the printing unit in the push-out direction.
